(19) United States
(12) Patent Application Publication
(10) Pub. No.: US 2017/0059357 A1
(43) Pub. Date: Mar. 2, 2017

(54) ELECTRONIC ANGLE SENSOR FOR INDICATOR INSTRUMENTS

(71) Applicant: Baumer Electric AG, Frauenfeld (CH)

(72) Inventors: Alf ZIPS, Kreuzlingen (CH); Daniel BRÄNDLE, Frauenfeld (CH); Joachim TIEDEKE, Kreuzlingen (CH)

(21) Appl. No.: 15/254,521

(22) Filed: Sep. 1, 2016

(30) Foreign Application Priority Data
Sep. 1, 2015 (DE) 10 2015 011 172.8

(51) Int. Cl. G01D 5/14; G01D 13/22

(52) U.S. Cl. CPC G01D 5/14; G01D 13/22

(57) ABSTRACT

Indicator instruments (1) have a good readability of a measured value, so that a simple visual checking of the measured value by the user is possible. An electronic angle sensor (17), is integrated into an exiting indicator instruments (1) with a front side (2) viewed indicator (7). The electronic angle sensor (17) includes a sensor unit (39) for the contactless detection of an angular position of the indicator (7). This allows an integration of an existing indicator instrument (1) into a control or regulation circuit for reference to the measured variable and/or the reaching of a preset switching point (30) in the form of a data signal. Good readability of the indicator instrument (1) is not lost and the measuring system is not modified. The angle sensor (17) is mountable on the front side (2) and the sensor unit (39) uses the indicator (7) as a transducer (8).

### CROSS REFERENCE TO RELATED APPLICATIONS

This application claims the benefit of priority under 35 U.S.C. §119 of German Application 10 2015 011 172.8 filed Sep. 1, 2015 the entire contents of which are incorporated herein by reference.

### FIELD OF THE INVENTION

The present invention pertains to an electronic angle sensor for indicator instruments provided with an indicator, to be viewed from a front side, with a sensor unit for the contactless detection of an angular position of the indicator.

### BACKGROUND OF THE INVENTION

Mechanical indicator instruments are preferably used for optically checking measurable process variables. The exclusively mechanically operating indicator instruments can be equipped with switches, which are almost exclusively triggered mechanically by the indicator motion, for the integration of said indicator instruments into a control or regulation [circuit] and for displaying the reaching of limit values.

The manufacture of such indicator instruments is expensive because of the complicated mechanics, especially in case of adjustable switching points.

Therefore, there are solutions, which detect the angle of rotation of the indicator of an analog indicator instrument in a contactless manner and at the same time convert it into an electrical signal for displaying with an indicator. Such solutions are known, for example, from DE 10 2009 056 259 A1 or EP 1 850 096 A1.

In both said solutions of the state of the art, the angle of rotation of the indicator is determined with a Hall sensor. The position of a permanent magnet fastened to the indicator and the rotational axis thereof is detected with this Hall sensor.

These solutions cannot be used universally. A hygrometer, which uses a horsehair as a transmitter of signals, may be mentioned here as an example. In case of such a hygrometer, a mounting of an additional weight due to the magnets will lead to a falsification of the measurement if not to the complete prevention of the measurement.

### SUMMARY OF THE INVENTION

An object of the present invention is thus to create an electronic angle sensor, which can be used in any desired analog indicator instruments.

According to the present invention, this is achieved for the electronic angle sensor of the type mentioned in the introduction by the angle sensor being configured as mountable on the front side of the indicator instrument and the sensor unit being configured to use the indicator as a transducer.

Since the indicator is used as a transducer, the contactless detection of the angular position of the indicator takes place directly. This has the advantage that compared to the solutions of the above-mentioned state of the art, no additional transducer, which may have an effect on the measurement, is necessary.

Thus, it is, for example, conceivable that smooth-running indicator instruments with small forces, deflecting the indicator, for example, a hygrometer based on a horsehair, may also be equipped with an angle sensor according to the present invention, without changing and influencing the original measuring apparatus of the indicator instrument in any way.

Further embodiments, which are each advantageous per se and can be combined with one another as desired, are explained below.

The electronic angle sensor according to the present invention can cover any desired indicator up to at most 75%, the electronic angle sensor can preferably cover the indicator up to at most about 50%, and especially preferably the electronic angle sensor can cover the indicator up to at most about 25%.

A covering of the indicator, which is preferably less than about 25%, does not impair the visibility of the display of the instrument.

The angle sensor can preferably be mounted centered about the axis of the indicator. Since the measuring scale of indicator instruments mostly extends in the circumferential direction at the tip of the indicator, the visibility or readability of the indicator instrument is not affected by such a central arrangement of the angle sensor.

In another advantageous embodiment of the electronic angle sensor, the sensor unit has measuring sectors, which are configured to measure an electrical and/or magnetic image of the indicator.

The measuring sectors may be arranged along a measuring circumference. The number of measuring sectors determines the achievable resolution of the angle sensor.

Thus, it is, for example, conceivable that only two measuring sectors may be provided for a binary display, i.e., the measuring variable is either above or below a set value.

For a more precise determination of the angular position of the indicator, a plurality of measuring sectors may be provided, wherein the extension, measured in the circumferential direction, of the measuring sectors may be on the order of the indicator extension along this measuring circumference, or else smaller than the indicator extension along this measuring circumference.

The measuring sectors may be arranged in a circle-sector-shaped or circular array about the mounting axis of the indicator. The arrangement of the measuring sectors may overlap the entire full circle, i.e., the angle of 360°.

The indicator of mechanical indicator instruments may have the indicator tip at one end and have a counterbalancing end at the opposite end. For an indicator configured in this way, an arrangement of the measuring sectors overlapping the full circle has the advantage that the measuring sectors overlapped by the counterbalancing end of the indicator can likewise be included in the analysis of the angular position.

Between the indicator tip and the counterbalancing end of the indicator, the support point of the indicator may have a circular configuration about the indicator axis and may have an outer support radius. The measuring sectors are preferably configured on a measuring radius, which lies outside of the outer support radius as viewed from the indicator axis.

The electrical and/or magnetic image of the indicator or indicator image is defined by the entirety of the electrical and/or magnetic measured values of the individual measuring sectors, which values are detected at the same time. A different indicator geometry is expressed by the fact that different measuring sectors are overlapped by the indicator and, in addition, the degree of overlapping of a measuring sector with the indicator may vary corresponding to the indicator geometry.

If a number of N measuring sectors are provided, then the indicator image detects at least the N discrete measured values of the N measuring sectors.

In the electronic angle sensor, a standardization module may be provided, which is configured to standardize the indicator image, so that the absolute values of the measuring sectors are insignificant for the measurement.

The indicator image is coded in the values of the individual measuring sectors and only two identical indicators in the area of the measuring sectors have an identical indicator image.

It is, for example, conceivable that an indicator tip may be configured as thin, but the opposite counterbalancing end has a markedly greater width than the tip of the indicator and thus more measuring sectors overlapped than the indicator tip.

A counterbalancing end configured in this way can be expressed in the indicator image by the fact that more measuring sectors detect a measured value in the area of the counterbalancing end. This may indicate an overlapping of the indicator, more so than in the area of the indicator tip.

If only a weighting of the individual measured values of the measuring sectors takes place, then the measured signal in relation to the angular position of the indicator tip is detected erroneously, shifted by 180°.

In the present invention, however, the sensor unit is configured to detect an indicator image and especially the relative position thereof to a zero point. Thus, an indicator of a desired configuration can carry out the measurement of the angular position.

The electronic angle sensor may be configured to provide an indicator image by the factory or else to set this indicator image during the first use of the angle sensor.

In addition to the possibility of using a great variety of indicator shapes for measuring the angular position of the indicator, an indicator with a defective shape or mounted at a different distance to the angle sensor may likewise be used for the measurement.

Thus, for example, indicators made of different material, which consequently also supply absolute measured values of differing sizes, can be measured with the electronic angle sensor in its angular position.

The measurement is carried out capacitively in another advantageous embodiment of the electronic angle sensor according to the present invention. The scanned indicator may be a dielectric material in case of a capacitive measurement. Thus, all non-metallic indicators may be provided with this configuration of the electronic angle sensor and be measured in their angular position.

As already described above, the distance of the dielectric indicator to the sensor unit in certain limits is not relevant. It is only advantageous when the distance between the indicator and the sensor unit is selected such that the change in the capacity of individual measuring sectors is still measurable because of the overlapping with the indicator.

In another advantageous embodiment of the electronic angle sensor, the capacitive measuring sectors are aligned radially to the mounting axis of the indicator.

The alignment of the measuring sectors radially to the mounting axis has the advantage that because of the circumferential arrangement, shorter distances of the capacitive measuring sectors to one another and a higher angular resolution can be achieved.

In another embodiment of the electronic angle sensor, it is advantageous when the measurement is carried out inductively. In this embodiment, the indicator may consist of any desired material capable of turbulent flow. This may be, for example, any desired metal, such as non-ferrous metal or aluminum. The inductive measurement of the indicator may be advantageous when the property of the indicator does not permit a capacitive measurement.

Different metals of the indicator lead to different absolute values of the measuring sectors; however, this is not relevant, as described above, since the electronic angle sensor is configured to use the indicator image for determining the angular position of the indicator.

In another advantageous embodiment of the electronic angle sensor, directly adjacent measuring sectors are arranged radially offset to one another and/or overlapping in the circumferential direction.

The sensor unit may thus have various measuring rings, the individual measuring sectors of which are arranged radially offset to an adjacent measuring sector located on a different measuring ring.

Thus, it is possible that a signal phase-shifted by 90° can be measured between the measuring sectors of a first measuring ring and the measuring sectors of a second measuring ring. Since both measuring rings can be analyzed in their combination, it is possible to increase the achievable angular resolution.

An arrangement of the measuring sectors in various measuring rings is advantageous since a coil, which represents the individual measuring sector, cannot have a small configuration as desired and thus limits the angular resolution.

Further, the electronic angle sensor may comprise an analysis unit, which is configured to record and to analyze the indicator image. Such an analysis unit may be, for example, an integrated switch or a microcontroller.

The analysis unit may be located directly in the angle sensor or be mounted outside of the indicator instrument.

The analysis unit may have a comparator module, which is configured to compare a currently measured indicator image with a stored indicator image, which corresponds to a zero position.

A computer module of the analysis unit can be configured to calculate the covered angle of the currently measured indicator image and the measured value resulting from this angle, for example, a temperature.

An output module may be configured to output the calculated variable via an output interface in the form of a data signal representing the measured variable.

In a simple configuration, the output interface may consist of data lines, which can be led out of the angle sensor into an area outside of the indicator instrument.

If the electronic angle sensor is mounted in an opening of the cover glass of the indicator instrument, it is thus advantageous when said data lines are led out of the indicator instrument under a black print applied to the cover glass. A plug socket provided with a port can be provided, into which the data lines lead and from which the measured value or the switching point signal can be tapped by means of a suitable connecting cable.

The analysis unit may have a standardization module which is configured to standardize a measured indicator image.

It is advantageous when the analysis unit comprises a computer module, which is provided to calculate the angular position of the measured indicator image in relation to the indicator image of the zero position.

In another embodiment of the electronic angle sensor, it is advantageous when the indicator at least partially covers at least two measuring sectors in each angular position.

The analysis unit may be configured to compare and/or to interpolate the measured values of two adjacent measuring sectors, at least partially covered by the indicator, by means of a comparator module and/or an interpolation module. The electronic angle sensor may thus provide an angular resolution, which makes it possible to detect an indicator position between measuring sectors.

In another advantageous embodiment of the electronic angle sensor, a switching point can be set within a predetermined display area of the indicator instrument at a desired angular position of the indicator, the reaching of which by the indicator triggers the output of a switching point signal via the output interface.

The analysis unit may be configured to output a switching point signal upon reaching a maximum value or upon reaching a minimum value. Further, a memory module may be provided, in which the switching point can be stored.

The switching point can be stored in the analysis unit especially in the form of the indicator image, which corresponds to the switching point. Said indicator image of the switching point may be either set by the factory or else be set by the user at the time of startup of the electronic angle sensor and be varied as desired during the operation.

The analysis unit may be configured to repetitively compare an indicator image corresponding to the angular position of the indicator with the stored indicator image of the switching point.

The analysis unit may have a correlation module and/or a comparator module, by means of which a measured indicator image can be correlated and compared with the stored indicator image, wherein the analysis unit can generate a trigger signal, which triggers the output of the switching point signal via the output interface upon agreement of the currently measured indicator image with the stored indicator image of the switching point.

In another embodiment of the electronic angle sensor, it is advantageous when at least one display element is provided for displaying and/or setting the switching point and the display element is configured as rotatable.

Since the indicator instrument is, furthermore, used for the visual display of the measured variable, it is advantageous when a switching point can also be displayed.

This display can be carried out, for example, by said display element, which can be formed on the side of the outer housing of the angle sensor facing the user.

The display element may consist of movable elements separated from one another, wherein, for example, the first movable element is mounted above a sensor unit and a second movable element is mounted below a sensor unit. It is likewise conceivable to arrange both movable elements on one side of the sensor unit. The sensor unit can detect the position of the two elements by both the top side and the bottom side of the sensor unit having measuring sectors. For setting the switching point, the movable elements are shifted to the respective switching point, the sensor unit not being moved along with them. As soon as the indicator agrees with one of the two movable elements, a signaling of the switching point takes place.

Furthermore, the display element may be a raised section with an indicator element, which can be set by rotating slightly to a desired switching point.

The indicator element may likewise be formed directly on the outer housing of the angle sensor.

In another advantageous embodiment of the electronic angle sensor, the sensor unit is nonrotatably connected to the display element.

Due to the nonrotatable connection between the sensor unit and the display element, the relative position between the individual measuring sectors and the display element is fixed, i.e., invariable. By contrast, the relative angular position between the display element and the stationary elements of the indicator instrument is variable.

This embodiment of the electronic angle sensor is especially advantageous when the absolute value of the measured variable currently measured by the indicator instrument and especially the output of same via the output interface do not have priority, but rather the main object of the electronic angle sensor configured in this way is to detect and signal the reaching of a switching point.

In another advantageous embodiment of the electronic angle sensor, the angle sensor has an actuating element, configured as manually actuatable, and a memory, wherein upon actuation of the actuating element, the memory stores the electrical and/or magnetic image of the indicator measured at the time of the actuation in the memory.

The actuating element may be configured as a mechanical sensor or else also as a capacitively operating sensor field.

The memory may preferably be a nonvolatile memory, in which the image of the indicator is stored. Further, an actuating element may be provided, which makes it possible to store a first switching point in case of actuation of the actuating element and to store a second switching point in case of a further actuation of the actuating element.

It is possible that the storage of the first switching point takes place by means of a simple actuation; by contrast, the storage of the second switching point may take place by means of a coded actuation pattern. This pattern may be, for example, two actuations of the actuating element carried out one shortly after the other.

In addition, the memory may have additional volatile and/or nonvolatile memory sections, in which, for example, interim values can be stored for calculations.

If the manually actuatable actuating element and the memory are used in combination with a measuring sensor immovable to the stationary parts of the indicator instrument, then at least one indicator image reflecting a reference value can be detected by means of the actuating element and be stored in the memory.

The analysis unit may be configured to allow a distinct assignment of a value of the measured variable to an angular position of the indicator. This assignment may be stored in the memory of the analysis unit in the form of a function.

The computer module of the analysis unit may comprise interpolation modules, which are configured to interpolate the measured indicator images. An angular resolution, which cannot be achieved by a purely selective outputting of the measuring sectors, can be achieved by an interpolation of the indicator image.

The interpolation module can thus provide angular positions, which are located between the measuring sectors, by interpolation of the N measured values of the measuring sectors.

If the actuating element is used in combination with a sensor unit which is rotatable in relation to the stationary components of the indicator instrument, then the angle sensor can detect and store a switching point in a simple manner by actuating the actuating element.

For this, the display element, which is visible to the user, especially the indicator element, is correlated with the indicator of the indicator instrument.

Since the sensor unit is connected nonrotatably to the display element, it also follows the rotation. If the actuating element is actuated in this angular position, then the analysis unit can detect and interpolate the indicator image and store it in the memory.

In another embodiment of the electronic angle sensor, the analysis element is advantageously configured to compare the stored electrical and/or magnetic image of the indicator with the currently measured electrical and/or magnetic image of the indicator and to signal a reaching of the at least one stored switching point upon agreement of a stored image with the current electrical and/or magnetic image.

The analysis unit can be configured to repetitively detect the respective current indicator image henceforth and to compare the current indicator image with the stored image of the switching point by means of the comparator module. Since the sensor unit was rotated along with the stored image, a current indicator image identical to the stored indicator image results only if the indicator of the indicator instrument reaches a value displayed by the display element.

If the indicator of the indicator instrument, for example, upon reaching the maximum temperature, is overlapping the display element, then the analysis unit detects a current indicator image and the comparator module detects that the measured indicator image is identical to the previously stored indicator image. The analysis unit analyzes the reported agreement and can initiate the output of a switching point signal via the output interface.

For detection whether a switching point is reached, an indicator image is thus used rather than an individual value, for example, a maximum value. This has the advantage that the setting of a switching point for indicators of any form is possible.

By storing a plurality of switching points, it is possible to monitor the operation of an apparatus within a range of the measured variable. Thus, for example, a temperature range, within which a device shall be operated, can be fixed.

In case of dropping below a minimum value or exceeding a maximum value, a switching point can be outputted by an output module via the output surface after the two switching points have been stored.

The analysis unit can be configured to output a switching point signal, which is identical for both switching points. It is likewise possible that the analysis unit outputs a switching point signal, which is different for distinguishing the switching points for said switching points. This is, for example, useful when an exceeding of the maximum value of a measured variable is more critical than the dropping below a minimum value of said measured variable.

Upon reaching the at least one stored switching point, the analysis unit may trigger the output of a switching point signal or alarm signal via the output interface.

An alarm output, which may be coupled, for example, with a GSM module, may be provided as an output interface. It is possible in this embodiment that an alarm signal signaling the reaching of a switching point can be transmitted via the GSM network with very minor time delay.

In another advantageous embodiment of the electronic angle sensor, it is mounted on a cover glass for an indicator instrument.

The angle sensor can extend through an opening in the cover glass and thus be connected to the cover glass. It is likewise possible that the angle sensor is mounted below or above the cover glass.

The cover glass connected to the angle sensor may replace the original cover glass of the indicator instrument, so that only the original cover glass of the indicator instrument can be replaced, without requiring additional modifications or manipulations of the indicator or of the indicator instrument.

The original readability of the display remains, moreover, guaranteed.

The electronic angle sensor may thus expand a plurality of mechanical indicator instruments with the functionality of the electrical output of the measured value and/or the monitoring of a switching point or a plurality of switching points.

Further, the cover glass of the electronic angle sensor may be formed with solar cells. These solar cells permit a self-sufficient operation of the electronic angle sensor far away from stationary power supply networks.

Furthermore, the cover glass may have areas, which are equipped with a touch function. Thus, the actuating element, for example, may be actuatable electrically rather than mechanically by means of capacitive scanning.

The touch function is advantageously configured such that the touch sensor is transparent and thus the visibility of the indicator instrument is not affected.

In an advantageous embodiment of a process for the contactless detection of an angular position of the indicator of an indicator instrument, the angular position of the indicator is detected from the front side of the indicator instrument and the indicator itself is used as a transducer.

It may be advantageous in said process when the angular position is detected as an electrical and/or magnetic measured variable. It is likewise advantageous when the detection of the transducer takes place such that an image of the indicator is detected.

In said process, an indicator image of the indicator is advantageously detected in a reference position and stored before measuring. Further, a temporary storage of one or more indicator images may be provided during the process, so that said storage indicator images can be used for interpolation and/or standardization and/or correlation.

In the process described, the correlation of a stored indicator image with a currently measured indicator image can take place and it is possible to analyze whether a switching point has been reached. Likewise, the output of a switching point signal during the process can be initiated upon reaching a switching point.

For setting a switching point, the display element can be rotated to the indicator during the process, the actuating element can be manually actuated, the indicator image can be detected, temporarily stored, interpolated and stored in a nonvolatile memory.

In the further course of the setting of the switching point, the display element can be rotated to the desired switching point, the current indicator image can be repetitively detected and correlated with the stored indicator image.

In the further steps of the process, it is possible to analyze whether the stored indicator image corresponds to the measured indicator image and a switching point signal can be outputted provided that the stored indicator image corresponds to the measured indicator image.

The present invention is explained below on the basis of exemplary embodiments with reference to the drawings. According to the above explanations, individual features of the exemplary embodiment described may be omitted when the advantage connected with these features does not apply in a certain application. Elements, which correspond to one another in terms of function and/or configuration, are each provided with the same reference numbers. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a mechanical indicator instrument of the state of the art;

FIG. 2 is a perspective view of an indicator instrument with an electronic angle sensor;

FIG. 3 is a section of the perspective view of an indicator instrument with electronic angle sensor;

FIG. 4 is a perspective view of a capacitive electronic angle sensor;

FIG. 5 is a perspective view of an inductive electronic angle sensor;

FIG. 6 is the design of an indicator image and the setting of a switching point;

FIG. 6a is a first indicator image; and

FIG. 6b is a second indicator image.

### DESCRIPTION OF THE PREFERRED EMBODIMENTS

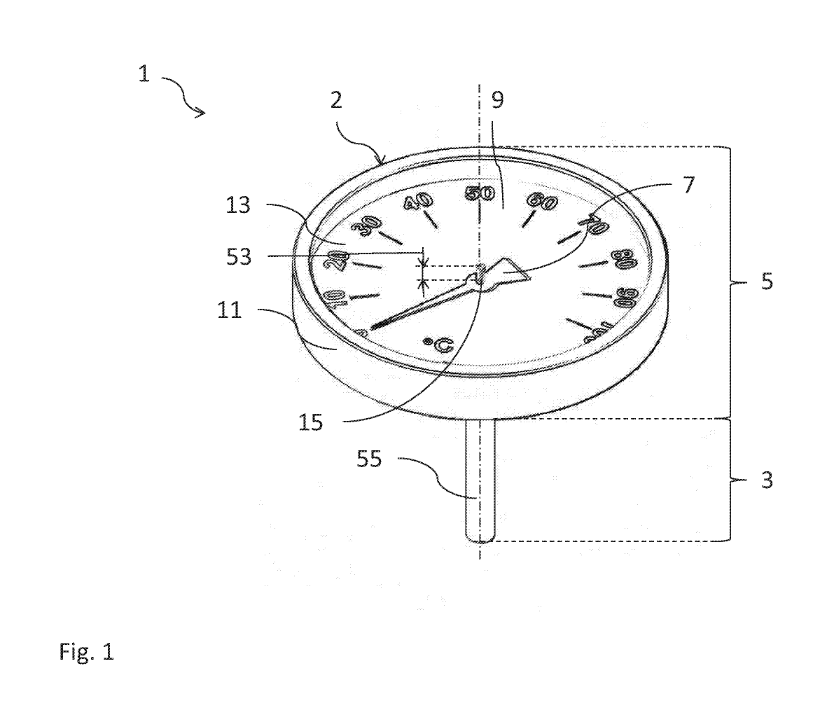

Referring to the drawings, an indicator instrument 1 of the state of the art is shown in FIG. 1. Such an indicator instrument 1 comprises a measuring unit 3 and a display unit 5, which in turn comprises an indicator 7, an instrument dial 9, a display housing 11 as well as a cover glass 13.

The measuring unit converts a measured variable into a proportional angle of rotation of the indicator axis 15, said angle of rotation being proportional to the measured variable.

The indicator 7 is connected nonrotatably to an indicator axis 15.

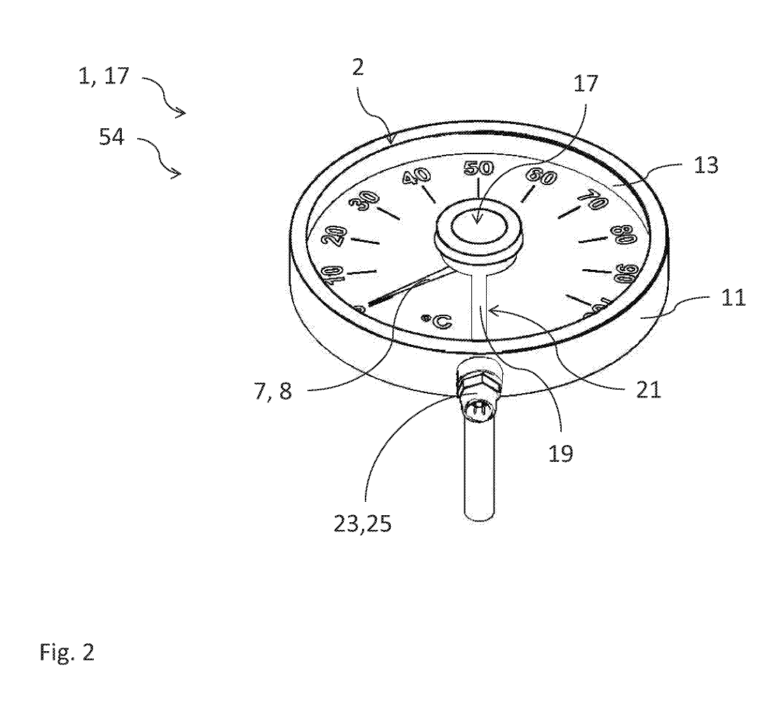

FIG. 2 shows an indicator instrument with an electronic angle sensor 17.

In addition to the technical features shown in FIG. 1, the embodiment of the indicator instrument shown in FIG. 2 additionally comprises a black print 19, which is printed directly on the top side of the cover glass 13. Under said black print 19, data lines (21, not visible) are led from the electronic angle sensor to the display housing 11 under the cover glass 13, wherein the not visible data lines open into an aggregate port 23, which represents the output interface 25.

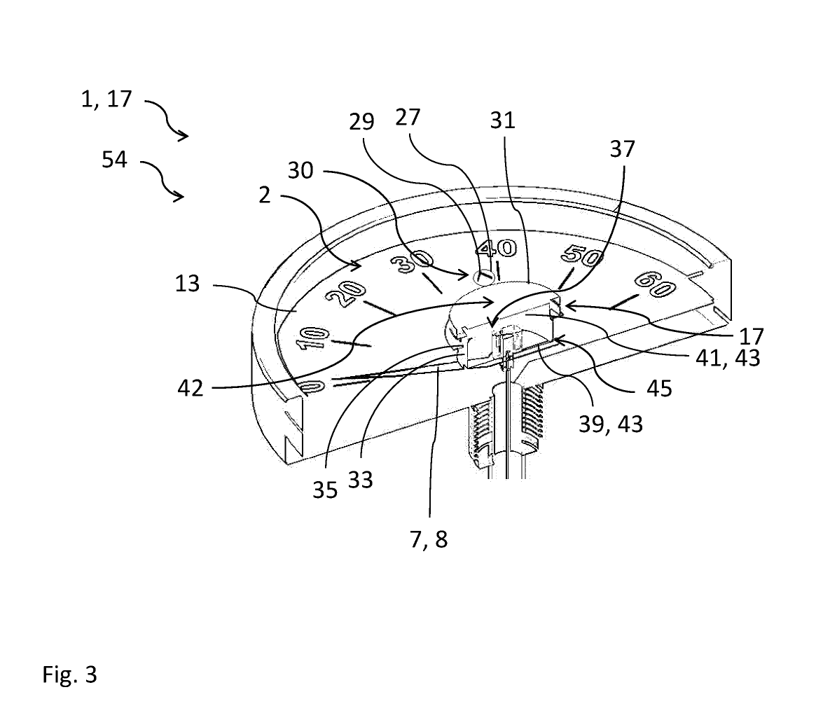

The indicator instrument 1 with an electronic angle sensor 17 is shown in a sectional, perspective view in FIG. 3. The electronic angle sensor 17 comprises a display element 27, which has an indicator element 29.

The indicator element 29 of the display element 27 points to a switching point 30.

In the present embodiment, the indicator element 29 is configured as a triangle embossed into the display element 27; however, it may be configured in any other form, for example, as a point formed on the actuating element 42.

The electronic angle sensor 17 comprises an upper housing part 31 and a lower housing part 33. Both housing parts 31, 33 are connected to one another, for example, locked into position, wherein a connection point 35 is led through an opening of the cover glass 13. The opening of the cover glass 13 is not visible in FIG. 3.

An actuating element 42, which can be configured as either movable separately and in relation to the housing part, or as a monolithic part of the upper housing part 31, is provided on the side of the upper housing part 31 facing the user.

The actuating element 42 may be configured to signal both optically and haptically the functions of the actuating element 42 that are available.

The two housing parts 31, 33 of the electronic angle sensor 17 form an interior space 37 of the angle sensor 17, in which the sensor unit 39 and the analysis unit 41 are located. Both the sensor unit 39 and the analysis unit 41 are configured as integrated switching circuits 43.

The sensor unit 39 is located in the lower housing part 33 of the angle sensor 17, the lower housing part 33 being opened on its side pointing in the direction of the indicator 7 such that the sensor unit 39 pointing in the direction of the indicator 7 closes the interior space 37 of the angle sensor 17. The sensor unit 39 is thus visible and accessible from outside of the angle sensor 17.

There is a measuring distance 45 between the sensor unit 39 pointing in the direction of the indicator 7 and the indicator 7 of the indicator instrument 1.

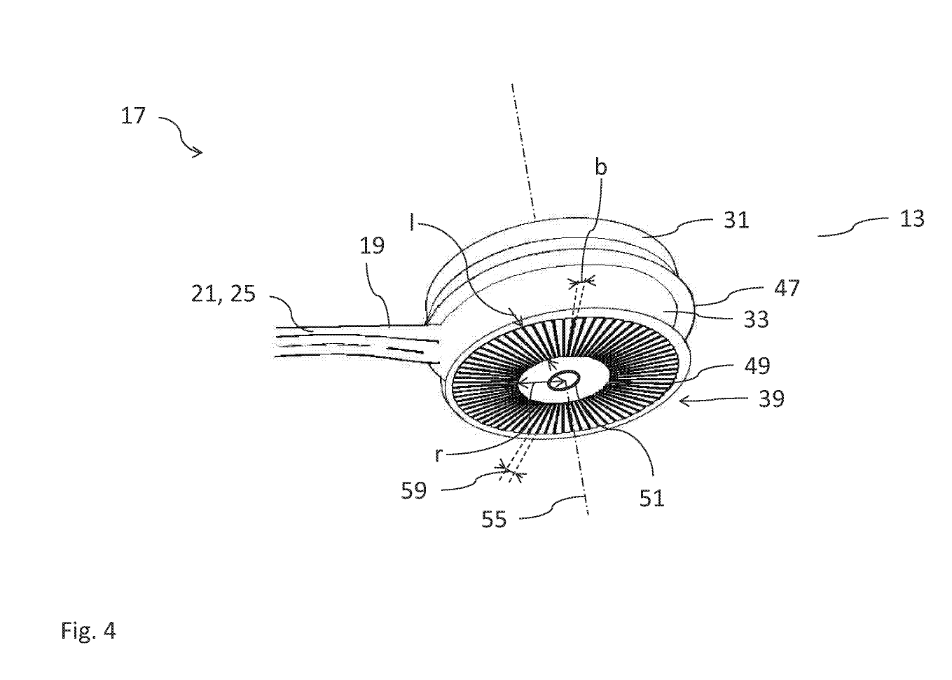

FIG. 4 show a capacitive electronic angle sensor 17. This comprises the upper housing part 31, the lower housing part 33, which is shown as semitransparent in FIG. 4, the output interface 25, which is configured in the form of two data lines 21, the sensor unit 39 as well as the cover glass 13, which has the black print 19.

A sealing element 47 between the upper housing part 31 and the cover glass 13 is provided at the connection point 35, which is located in the not visible opening of the cover glass 13. The sealing element 47 is advantageous to reduce or even to prevent a penetration of dust and fluids behind the cover glass 13.

Further, individual measuring sectors 49 of the sensor unit 39 are shown. These measuring sectors extend circumferentially about an axle mount 51. The axle mount 51 is used to receive an end of the indicator axis 15 protruding beyond the indicator 7 (see FIG. 1), without the indicator axis 15 contacting the angle sensor 17.

The axle mount 51 also makes it possible to set the measuring distance 45 between the indicator 7 and the sensor unit 39 independently of the axle projecting length 53.

The measuring sectors 49 are configured as flat electrodes in the embodiment of the electronic angle sensor 17 shown in FIG. 4. The measured capacity of the electrodes 50 is dependent on whether a dielectric material is located in the vicinity of the electrodes 50 and how large the overlap between the indicator and the surface of the electrodes 50 is.

The indicator axis (not shown in FIG. 4), which is symbolized here by an axis of rotation 55, runs in the mounted state 53 centrally through the axle mount 51. In the mounted state 53, the axis of rotation 55 shown in FIG. 4 is identical to the axis of rotation 55 shown in FIG. 1.

The measuring sectors 49 have a length 1 and a width b. The length 1 extends in the radial direction and the width b in the circumferential direction. The achievable angular resolution of the sensor unit 39 is dependent on how many measuring sectors 49 are located in an angle segment. If the measuring sectors 49 are arranged around the entire circumference, i.e., over an angle of 2, then the angular resolution results from the quotient of 2 and the number N of measuring sectors 49.

The achievable angular resolution of the sensor unit 39 is thus dependent on the width b of the measuring sectors 49, on the distance 59 between the measuring sectors 49 as well as on the radial distance r of the measuring sectors 49 from the axis of rotation 55.

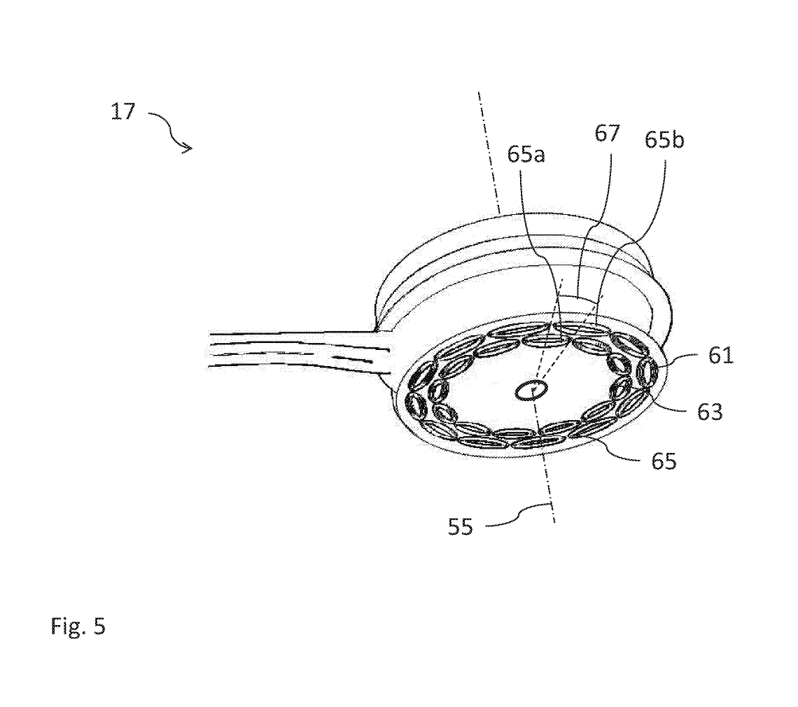

FIG. 5 shows an inductive electronic angle sensor 17. This comprises essentially the same elements as the capacitive electronic angle sensor 17 from FIG. 4.

The sensor unit 39 of the exemplary embodiment of the electronic angle sensor 17 shown in FIG. 5 comprises an inner coil ring 61 and an outer coil ring 63.

Both coil rings 61, 63 comprise a plurality of single coils 65, each of which represents a measuring sector 49 of the inductive electronic angle sensor 17.

The single coils 65 preferably have at least one winding.

The single coils 65, which are provided on different coil rings 61, 63 and are adjacent, have an angular offset 67, which is shown, in the example of the single coils 65a and 65b in FIG. 5. The angular offset 67 is selected, so that the measured values of the single coils 65a and 65b are phase-shifted to one another by 90°. This arrangement increases the angular resolution.

Both the measuring sectors 49 configured as electrodes 50 in FIG. 4 and as single coils 65 in FIG. 5 may be part of the integrated switching circuit 43.

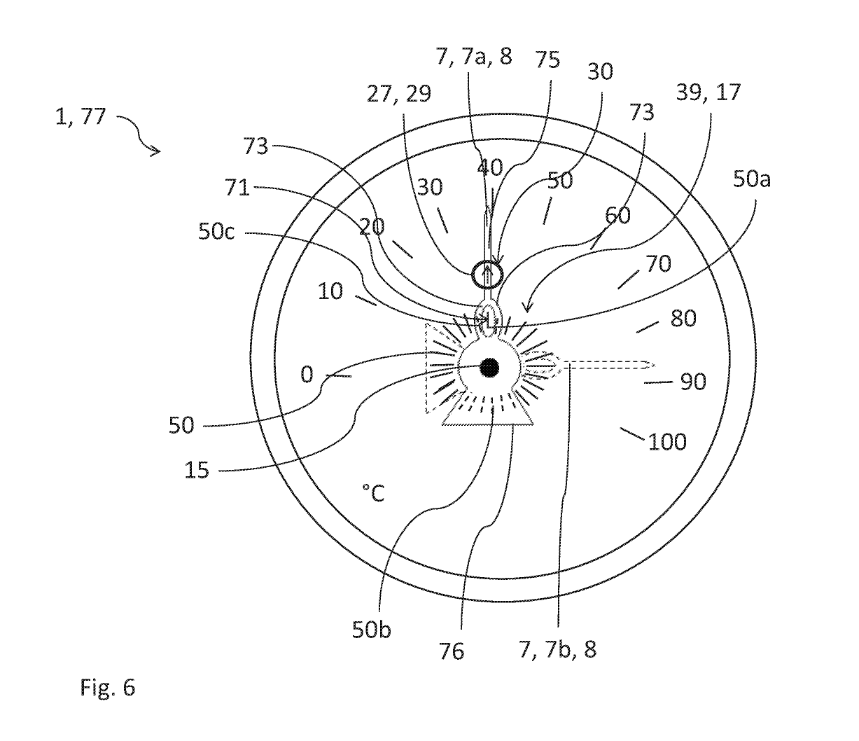

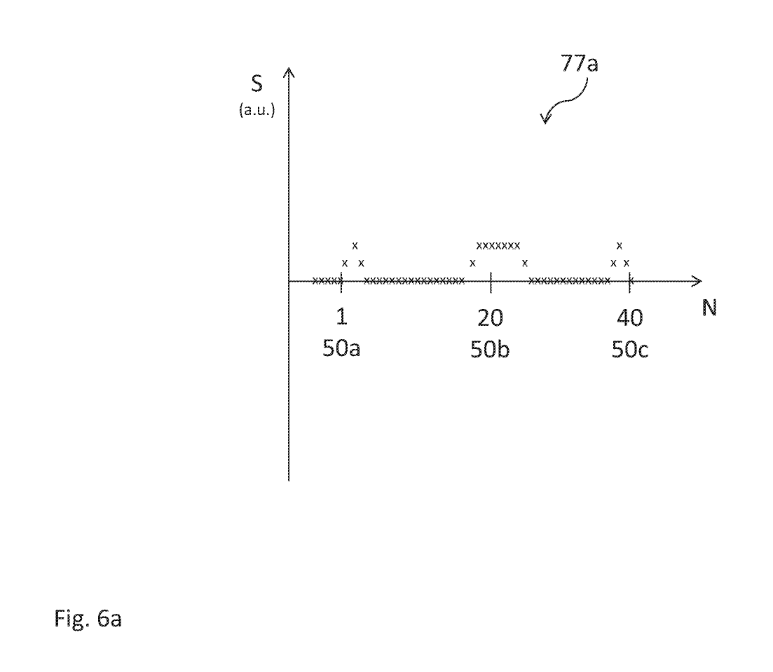

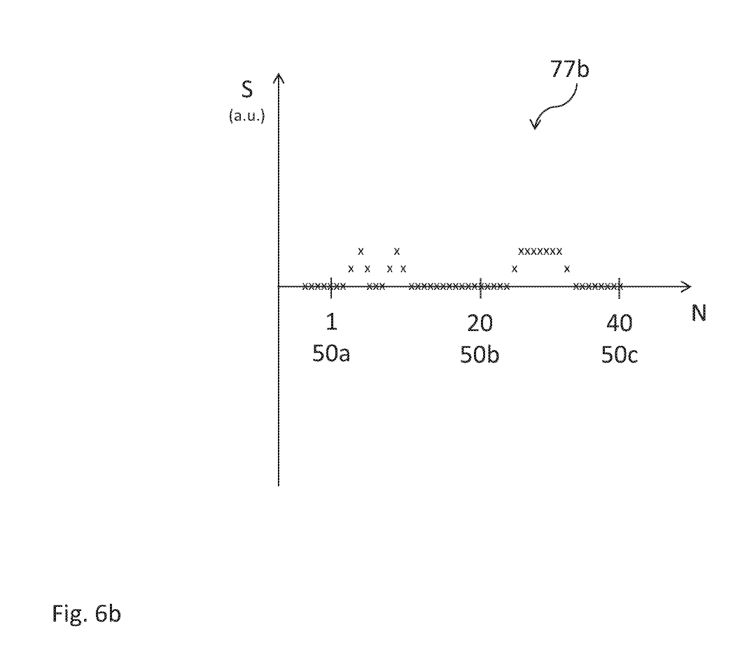

With reference to FIG. 6, the setting of the switching point 30 and the design of the indicator image 77 shall be explained on the basis of a configuration not limiting the present invention.

The indicator instrument 1 is shown with an indicator 7 in a first indicator position 7a. The indicator instrument 1 can be used for temperature measurement in the embodiment shown in FIG. 6, wherein a process is monitored, the temperature of which is approximately between 32° C. and 65° C. and the minimum temperature of about 32° C. may not be dropped below.

FIG. 6 likewise shows the display element 27 as well as the sensor unit 39 with forty electrodes 50 of a capacitive electronic angle sensor 17 as an example. The housing parts of the angle sensor 17 are not shown in order to illustrate the position of the individual electrodes 50 to the indicator 7.

The display element 27 displays the switching point 30 with its indicator element 29.

In the embodiment shown, the indicator 76 has a recess 71 and two webs 73, which converge in the indicator tip 75 and enclose the recess 71.

At the opposite end of the indicator, this [indicator] has a counterbalancing end 76, which has the form of a dovetail and thus overlaps more electrodes 50 than the individual webs 73 of the indicator tip 75.

FIG. 6a likewise shows a first indicator image 77a. The first indicator image 77a is composed of the individual signals S of the respective electrodes 50 in arbitrary units. These signals S are plotted over a running index n of the electrodes 50.

Depending on the configuration of the indicator in the area of the sensor unit, a different indicator image 77 is obtained as a result.

In the example shown, the running index n=1 is assigned to the electrode 50a, the running index n=20 to the electrode 50b and the running index n=40 to the electrode 50c. Said assignment is only selected as an example to illustrate the principle of the indicator image 77.

In the first indicator position 7a, the indicator 7 overlaps the electrodes 50 such that the measured capacity of the individual electrodes 50 plotted over the running index n of the electrodes 50 produces the first indicator image 77a. In this case, the capacity is plotted as signal S in arbitrary units.

It can be clearly seen from the first indicator image 77a that it is not possible to conclude the angular position of the indicator 7 by means of an analysis of the maximum value and of the weighted maximum value. In the case of a weighting during the measurement, the counterbalancing end 76 overlapping the plurality of electrodes 50 would suggest an erroneous display of about 100° C.

If the temperature of about 32° C. shall be fixed as a switching point 30 of the minimum temperature in the example of FIG. 6 shown, then the display element 27 is correlated with the indicator 7.

In another embodiment, it may be sufficient to correlate the indicator element 29, which can be formed on the upper housing part 31, with the indicator 7. The indicator element 29 may be, for example, a point, or else any other form of a marking on the upper housing part 31.

This correlation can take place in any desired indicator position, i.e., not necessarily in the indicator position 7a shown, since the sensor unit 39 and thus the entirety of the electrodes 50 are connected nonrotatably to the display element 7 and thus the electrode 50a always lies above the recess 71 of the indicator 7 in case of correlation of the display element 27 with the indicator 7.

By actuating the actuating element (not shown), the first indicator image 77a can be stored in a memory, not shown.

After inputting the first indicator image 77a, the display element 27 is rotated to the switching point 30. In FIG. 6, this is the indicator position, which corresponds to a temperature of about 38° C.

If the temperature rises to about 88° C., then the indicator 7 is in a second indicator position 7b shown by a dotted line. In the second indicator position 7b, the indicator overlaps other electrodes 50 of the sensor unit 39, since the position of the sensor unit 39 was not changed in relation to the indicator instrument 1.

In the second indicator position 7b, a second indicator image 77b is detected.

FIG. 6b shows a second indicator image 77b. Since the indicator 7 was rotated by 90° from the first indicator position 7a to the second indicator position 7b, this second indicator image 77b is offset by ten electrodes 50 in relation to the first indicator image. The second indicator image 77b is likewise shown in FIG. 6.

If the temperature drops to 38° C. during the operation, then the first indicator image 77a is obtained only precisely upon reaching the indicator position, which corresponds to a temperature of 38° C.

If this is the case, then the analysis unit, not shown, will detect the reaching of the switching point 30 and bring about the output of a switching point signal, as described above.

While specific embodiments of the invention have been shown and described in detail to illustrate the application of the principles of the invention, it will be understood that the invention may be embodied otherwise without departing from such principles.

1. An electronic angle sensor for indicator instruments provided with an indicator, to be viewed from a front side of the indicator instrument, the electronic angle sensor comprising:
a sensor unit for a contactless detection of an angular position of the indicator, wherein the angle sensor is configured as mountable at the front side of the indicator instrument and the sensor unit is configured to use the indicator as a transducer of the sensor unit.

2. An electronic angle sensor in accordance with claim 1, wherein the sensor unit comprises measuring sectors, which are configured to measure an electrical and/or magnetic image of the indicator.

3. An electronic angle sensor in accordance with claim 2, wherein the measuring sectors are capacitive measuring sectors and the measurement, by the capacitive measuring sectors, is carried out capacitively.

4. An electronic angle sensor in accordance with claim 3, wherein the capacitive measuring sectors are aligned radially to a mounting axis of the indicator.

5. An electronic angle sensor in accordance with claim 2, wherein the measuring sectors are inductive measuring sectors and the measurement, by the inductive measuring sectors is carried out inductively.

6. An electronic angle sensor in accordance with claim 5, wherein directly adjacent measuring sectors are arranged radially offset to one another and/or overlapping in a circumferential direction.

7. An electronic angle sensor in accordance with claim 2, wherein the indicator at least partially covers at least two measuring sectors in each angular position.

8. An electronic angle sensor in accordance with claim 1, further comprising an output interface and a switching point, the reaching of which by the indicator triggers the output of a switching point signal via the output interface, wherein a position of the switching point is settable within a predetermined range at a desired angular position of the indicator.

9. An electronic angle sensor in accordance with claim 8, further comprising at least one display element displaying and/or setting the switching point, wherein the at least one display element is configured as rotatable.

10. An electronic angle sensor in accordance with claim 9, wherein the sensor unit is nonrotatably connected to the at least one display element.

11. An electronic angle sensor in accordance with claim 9, further comprising an analysis unit, an actuating element configured as manually actuatable, and a memory, wherein the electrical and/or magnetic image of the indicator, measured at the time of the actuation, is stored in the analysis unit upon actuation of the actuating element.

12. An electronic angle sensor in accordance with claim 11, wherein the analysis unit is configured to compare the stored electrical and/or magnetic image of the indicator with a currently measured electrical and/or magnetic image of the indicator and to signal a reaching of the at least one stored switching point in the case of agreement of a stored image with the current electrical and/or magnetic image of the indicator.

13. An electronic angle sensor in accordance with claim 1, wherein a cover glass is provided for the indicator instrument, on which the electronic angle sensor is mounted.

14. A process for the contactless detection of an angular position of the indicator of an indicator instrument, the process comprising the steps of:
providing an electronic angle sensor comprising a sensor unit for a contactless detection of an angular position of the indicator, wherein the angle sensor is configured as mountable at the front side of the indicator instrument and the sensor unit is configured to use the indicator as a transducer of the sensor unit;
mounting the electronic angle sensor on or adjacent to the front side of the indicator instrument; and
detecting the angular position of the indicator from the front side of the indicator instrument and the indicator itself is used as the transducer.

15. A process in accordance with claim 14, wherein:
the sensor unit comprises measuring sectors configured to measure an electrical and/or magnetic image of the indicator; and
the indicator at least partially covers at least two measuring sectors in each angular position of the indicator.

16. A process in accordance with claim 15, wherein:
the measuring sectors are capacitive measuring sectors and the measurement, by the capacitive measuring sectors, is carried out capacitively; and
the capacitive measuring sectors are aligned radially to a mounting axis of the indicator.

17. A process in accordance with claim 14, wherein:
the measuring sectors are inductive measuring sectors and the measurement, by the inductive measuring sectors is carried out inductively; and
directly adjacent measuring sectors are arranged radially offset to one another and/or overlapping in a circumferential direction.

18. A process in accordance with claim 14, wherein:
the electronic angle sensor further comprises an output interface and a switching point, the reaching of which by the indicator triggers the output of a switching point signal via the output interface, wherein a position of the switching point is set within a predetermined range at a desired angular position of the indicator;
the electronic angle sensor further comprises at least one display element displaying and/or setting the switching point;
the at least one display element is configured to be rotatable;
the sensor unit is nonrotatably connected to the at least one display element.

19. A process in accordance with claim 14, wherein:
the electronic angle sensor further comprises an analysis unit, an actuating element configured as manually actuatable, and a memory;
the electrical and/or magnetic image of the indicator, measured at the time of the actuation, is stored in the analysis unit upon actuation of the actuating element;
the analysis unit is configured to compare the stored electrical and/or magnetic image of the indicator with a currently measured electrical and/or magnetic image of the indicator and to signal a reaching of the at least one stored switching point in the case of agreement of a stored image with the current electrical and/or magnetic image of the indicator.

20. A process in accordance with claim 14, wherein:
a cover glass is provided for the indicator instrument; and
the electronic angle sensor is mounted on the cover glass.
